(19) United States
(12) Patent Application Publication
(10) Pub. No.: US 2024/0157378 A1
(43) Pub. Date: May 16, 2024

(54) Water Conserving Showerhead and Associated Methods of Use

(71) Applicant: Dry Water Inc., Mason, OH (US)

(72) Inventors: Steve Scott Burns, Ponte Vedra, FL (US); Jack Dale Browning, Cincinnati, OH (US)

(21) Appl. No.: 18/507,855

(22) Filed: Nov. 13, 2023

Related U.S. Application Data
(60) Provisional application No. 63/383,667, filed on Nov. 14, 2022.

(51) Int. Cl. B05B 1/30; B05B 1/18

(52) U.S. Cl. CPC B05B 1/302; B05B 1/18

(57) ABSTRACT

A water conserving showerhead saves over 70 % of the water used during a traditional shower, while providing the same comfort and cleaning effects. The showerhead may include a motion sensor, a personal computer (PC) board, a temperature sensor, and a ball valve. The showerhead is used by first turning on the showerhead via an application (app) on a mobile device and the PC board or similar means. When the showerhead is started, the ball valve opens and allows the cold water within the showerhead and pipes to exit. When the temperature sensor detects the desired water temperature, the ball valve is closed, and the shower is ready for the user. During the shower, the user may step out of the active shower area for numerous reasons. A motion sensor detects when the user steps outside of the active shower area, and the ball valve is closed, shutting off the water. When the user steps back into the active shower area, the motion sensor detects the user's presence, opens the ball valve and the shower continues as normal.

### BACKGROUND OF THE INVENTION

This claims the benefit of U.S. Provisional Patent Application Ser. No. 63/383,667, filed on Nov. 14, 2022, herein incorporated by reference in its entirety.

This invention relates generally to showerheads. More specifically, this invention relates to showerheads that conserve water and are further capable of communication, along with the gathering and transmitting of data.

Humankind all requires a source of fresh water for both drinking as well as other uses such as cooking and bathing. Fresh water is reaching scarcity levels not seen in current history. Further, the majority of the water on planet earth, 96%, is saline or saltwater, which is not fit for human consumption. Even further, of the available freshwater, 68% is frozen in ice and glaciers, while 30% is groundwater. This leaves only 2% of freshwater available for human consumption and usage.

Presently, no substitute or replacement for freshwater is available, and it is absolutely needed to sustain life. Therefore, to supply freshwater we need methods to either convert saltwater into freshwater or to conserve the water we already have available. Currently saltwater conversion is expensive and limited. Further, transporting and distributing vast volumes of converted saltwater from the coast across the country is difficult and energy intensive.

Therefore, there is a great need for solutions that conserve the small volume of freshwater that we have available for human consumption and usage.

### SUMMARY OF THE INVENTION

This invention is a water conserving showerhead that is capable of saving over 70% of the water used during a traditional shower, while providing the same comfort and cleaning effects.

The showerhead according to various embodiments of this invention is comprised of a motion sensor, a personal computer (PC) board, a temperature sensor, and a ball valve. The showerhead is used by first turning on the showerhead via an application (app) on a mobile device and the PC board or similar means. When the showerhead is first started, the ball valve opens and allows the cold water within the showerhead and pipes to exit. When the temperature sensor detects the desired water temperature, the ball valve is closed, and the shower is ready for the user.

The user can now enter the active showering area underneath the showerhead. When the motion sensor detects the user in the active showering area, the ball valve is opened and water at the proper temperature is dispensed, allowing the user to shower as normal.

During the shower, the user may step back or out of the active shower area for numerous reasons, such as applying soap or shampoo. The motion sensor detects when the user steps outside of the active shower area, and the ball valve is closed, shutting off the water. When the user steps back into the active shower area, the motion sensor detects the user's presence, opens the ball valve and the shower continues as normal.

This invention according to various embodiments is compliant with current plumbing standards and designed to be installed within minutes on any system which utilizes the ½″ National Pipe Tapered (NPT) threads, also known as ANSI/ASME B1.20.1 pipe thread standard. Since this is almost every shower installation, this invention can be broadly implemented anywhere in any location that utilizes this standard. Further, this invention in various embodiments may include a generator which creates the electricity needed to run the showerhead. Therefore, the showerhead is plug and play, without the need for an external power source.

In the United States, the average shower requires 29 gallons of water. With this invention, a shower that offers the same comfort and cleaning effect may take as little as 8 gallons. If this invention was implemented across Los Angeles County California, the showerhead would save an estimated 1.2 billion gallons of water per week in that county alone.

Due to the PC board and other components, this invention is further capable of gathering water usage data and transmitting that usage data to user devices. This enables a user to be aware of their water usage. Further this invention is capable of being integrated into many of today's voice activated and Wi-Fi controlled systems.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 shows a front left prospective view of a first embodiment of this invention;

FIG. 2 shows a left elevation view of the embodiment of FIG. 1 of this invention;

FIG. 3 shows a rear elevation view of the embodiment of FIGS. 1-2 of this invention;

FIG. 4 is a perspective exploded view showing the internal components of the first embodiment of this invention;

FIG. 5 shows a cross-sectional view of the first embodiment of this invention;

FIG. 5A is a cross-sectional view taken along line 5A-5A in FIG. 1;

FIG. 6 is a flowchart describing a method of operation of one embodiment of this invention;

FIG. 7 is a first half of a flow chart describing the logic for operation of one embodiment of this invention; and

FIG. 8 is a second half of the flow chart presented in FIG. 7.

### DETAILED DESCRIPTION OF THE INVENTION

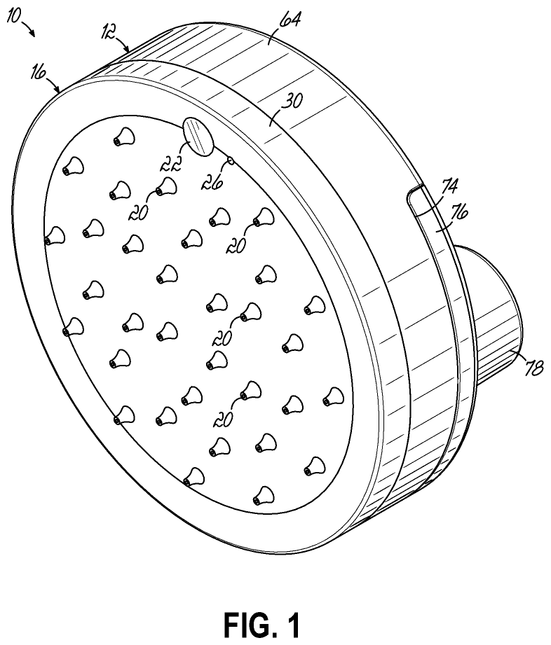

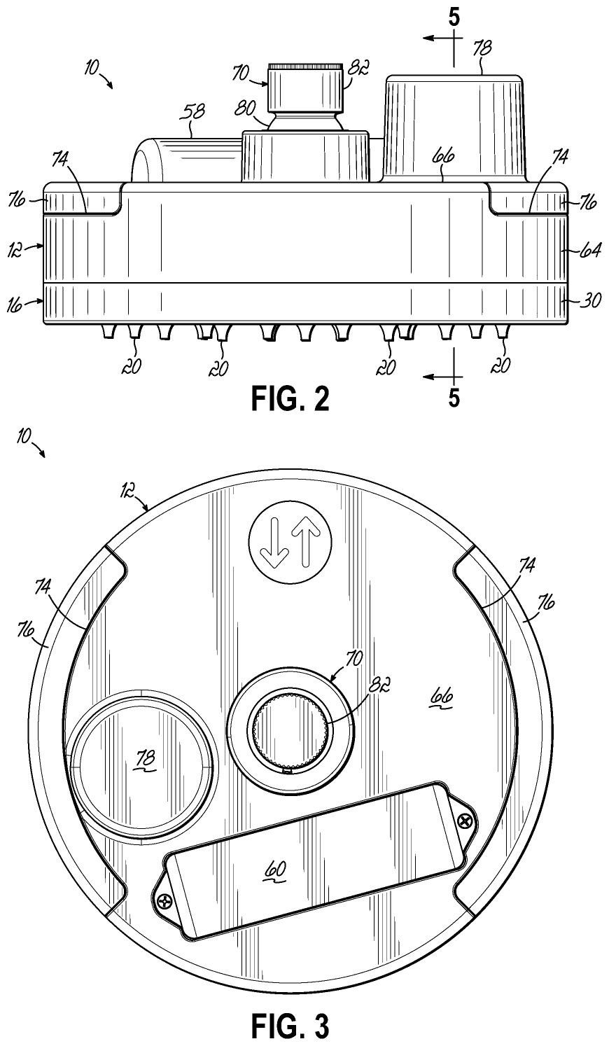

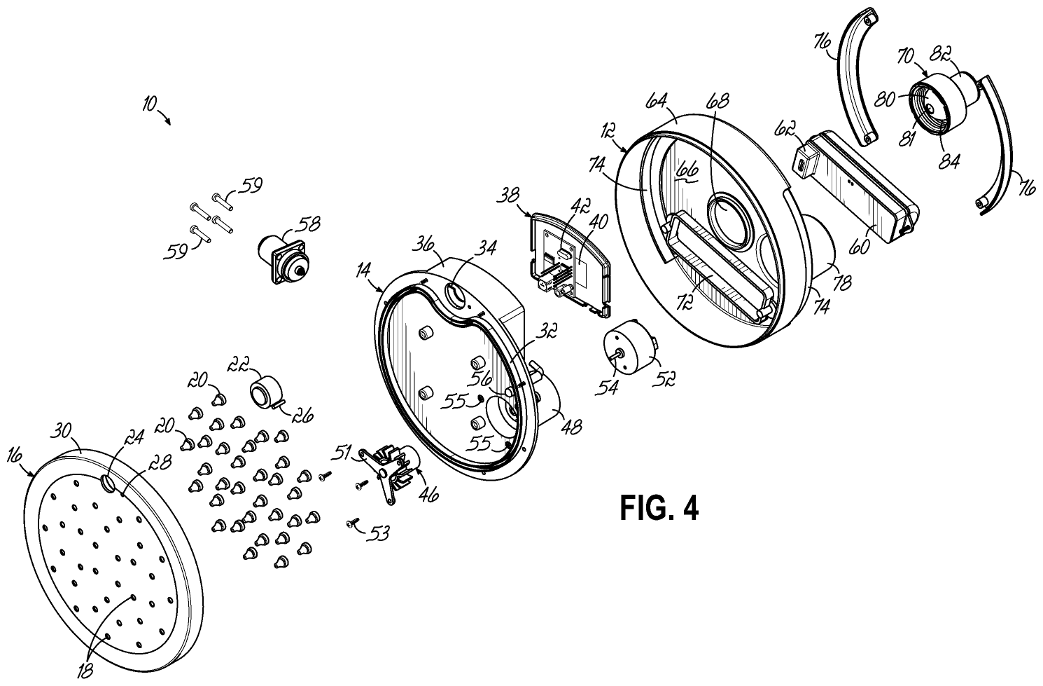

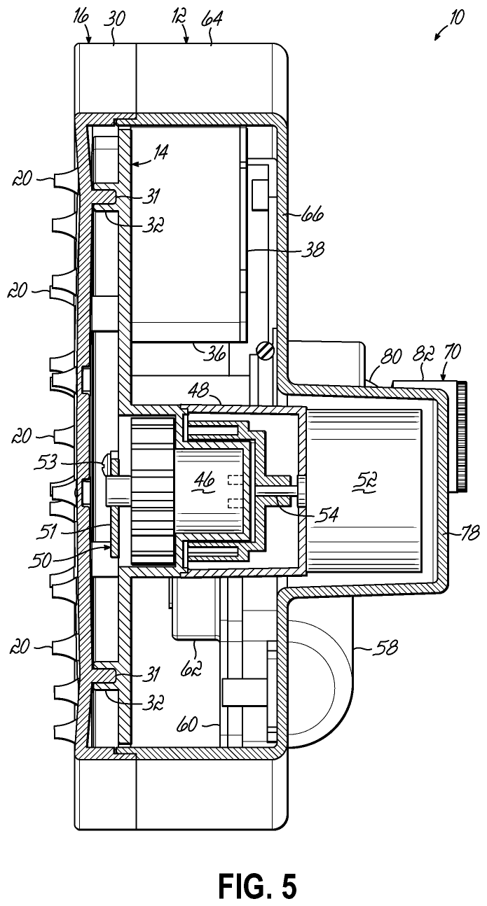

This invention in various embodiments is a water conserving showerhead 10 as shown in FIGS. 1-3. The components of the showerhead 10 according to one embodiment are shown in FIG. 4 in exploded fashion to better identify the various components. The showerhead 10 of this embodiment includes three main structural members, an aft housing 12, a chassis plate 14 and a shower face 16. The shower face 16 may have a number of holes 18 therein with one of a number of shower nozzles 20 seated in each hole 18. In one embodiment, there are thirty-three holes 18 and associated shower nozzles 20 through which the water exits the showerhead 10. An ultrasonic motion sensor 22 is seated in a mounting hole 24 on the shower face 16 and a light guide 26 is also mounted in a hole 28 in the shower face 16.

The shower face 16 has a peripheral lip 30 and an annular rib 31 which mates the shower face 16 to an upstanding dual rim 32 on a confronting face of the chassis plate 14. The chassis plate 14 has a silicone sleeve member 34 to receive the ultrasonic sensor 22 projecting through the shower face 16. The ultrasonic sensor 22 is received into a printed circuit board (PCB) housing 36 on the back of the chassis plate 14. A PCB or controller 38 is seated within the PCB housing 36 and operably coupled to the ultrasonic sensor 22. A Wi-Fi antennae 40 may be mounted to the PCB 38 as well as a mode switch 42.

The chassis plate 14 has a hole in its face which receives a turbine bushing spacer and shaft assembly 46 on the front of the plate 14 and a motor mount 48 on the opposite side of the plate 14. A turbine shaft retainer 50 is also coupled to the turbine bushing and shaft assembly 46. The turbine retainer 50 may have three arms 51, each of which is secured to the chassis plate 14 by a screw 53 seated in a hole 55 in the plate 14. A DC motor 52 has a drive shaft 54 projecting from it and the drive shaft 54 is operatively coupled to the turbine bushing spacer and shaft assembly 46 when the DC motor 52 is seated in the motor mount 48 on the back of the chassis plate 14. A motor housing 55 projects rearwardly from the aft housing 12 to contain the motor 52 in the assembled showerhead 10. A temperature sensor 56 is also mounted to the front face of the chassis plate 14. A solenoid assembly 58 is mounted via fasteners 59 radially to the chassis plate 14 opposite from the motor mount 48. A battery cell 60 with digikey holder 62 is also mounted to the back face of the chassis plate 14.

The aft housing 12 is cup shaped with a peripheral sidewall 64 which mates with the peripheral lip 30 of the shower face 16 when the showerhead 10 is assembled. The aft housing 12 includes an end wall 66 with a central aperture 68 therein to receive a water inlet assembly 70 through which the water enters the showerhead 10 to ultimately be expelled out of the shower nozzles 20. A seat 72 is formed on the end wall 66 which is sized and shaped to receive the battery cell 60 in the assembled showerhead 10. Each of a pair of spaced arcuate notches 74 is formed at the junction between the sidewall 64 and the end wall 66. Each arcuate notch 74 is sized and shaped to receive one of two touch on/off partial rings 76 to allow a user to manually operate the assembled showerhead 10. A tubular motor housing 78 projects rearwardly from the end wall 66 to receive therein the DC motor assembly 52 when the components are assembled as the showerhead 10.

The showerhead 10 may connect to any ½″ NPT standard shower pipe. In other embodiments, a swivel ball 80 has a shank 82 that can be designed to further accommodate other shower and plumbing standards. In such embodiments, the swivel ball shank 82 further provides a swivel and rotate function that allows the user to position the showerhead 10 in a desired location and direction. The ball valve 80 is seated on a seal ring 84 to seal against the leakage of water flowing through the ball valve 80.

The housing of the showerhead 10 according to various embodiments of this invention is both a structural component that provides a structure to hold all the components and an exterior shell or surface that is visible to the user. In one embodiment, the housing is further comprised of a rear flange. The rear flange may be a plate or structural member which provides a mounting location for the swivel ball valve.

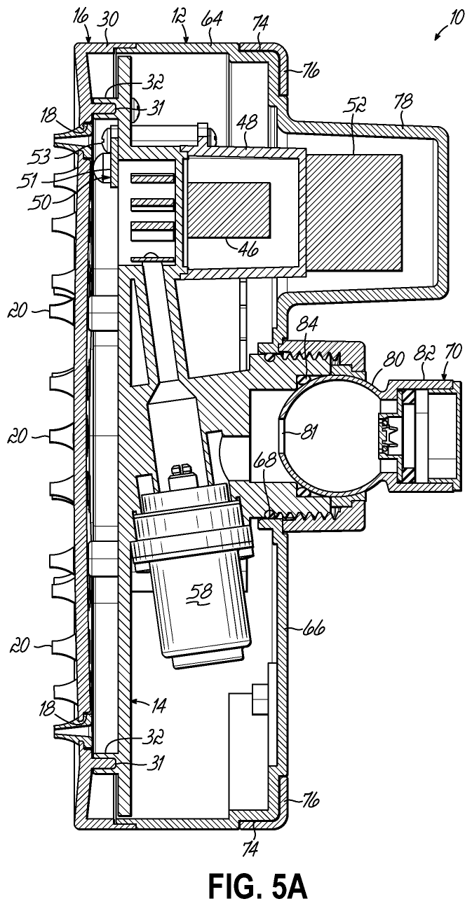

The ball valve 80 of this invention is a means for allowing or restricting the flow of water through an aperture 81 in the ball valve 80 and is best seen in the cross-sectional view of FIG. 5A. The ball valve 80 of this invention can be embodied through any number of valves and other means of restricting water flow. This embodiment utilizes a solenoid actuated ball valve which is electrically activated. The ball valve 80 when opened allows a full stream of water to pass without restricting pressure or volume. When the ball valve 80 is closed, the water stream is stopped. The water flow through the showerhead 10 can be seen in the cross-sectional view of FIG. 5A from the water inlet assembly 70 through the ball valve 80 and ultimately out of the nozzles 20. The ball valve 80 of one embodiment is attached to the swivel ball valve, although in further embodiments the ball valve can be placed in other locations and be attached to or integrated into other components.

The PC board 38 of this invention may be a device that connects in line with the plumbing of this invention and provides the capability to gather and process data, while also allowing communications via Wi-Fi and other technologies. The PC board 38 may be further comprised of a temperature sensor 56 and a Wi-Fi antennae 40.

The temperature sensor 56 being able to the detect the water temperature as it passed through the showerhead 10. The Wi-Fi antennae 40 may be capable of transmitting and receiving data with other devices. Other embodiments of this invention may utilize other communication technologies such as cellular or Bluetooth. Further, other embodiments of the PC board 38 may utilize any number of means or systems to gather and process data such as Arduino or raspberry pi.

A generator of various embodiments of this invention may be a means for creating and storing electricity. Since this invention may be a stand-alone system that has no external power source, a generator may be used to create and store electricity. The generator may be connected in line with the plumbing of this invention and may be electrically connected to the PC board 38 and other electrical components. In further embodiments of this invention, any means of creating and storing electricity may be utilized. In one embodiment, a turbine generator 50 is used. This turbine generator uses the flow of water to spin the turbine and create electricity. The electricity may be stored using any number of means such as a battery 60 or capacitor.

Within one embodiment of this invention, the water travels from the swivel ball valve 80 through the ball valve, the PC board 38, and the generator 50 until it reaches the shower face 16 at the front of the housing. This shower face may be in the form of a front collar which is a plate or structural member that provides support to the internal components. Mounted or integrated into the front collar may be a diffuser. The diffuser may be a device for diffusing and dispensing the water into the front of the housing.

The front of the housing may include a spray base as part of the shower face 16. This spray base creates the spray pattern for the water exiting the showerhead. In one embodiment, the spray base may be comprised of a front and a rear spray base. The rear spray base may be mounted to the front side of the front collar and form a first portion of a cavity. The front spray base may form a second portion of the cavity and contain a number of spray apertures or holes. When water is dispensed from the diffuser into the water cavity formed by the spray base, the water is forced or sprayed out of the spray apertures or holes in the front spray base.

A motion sensor of this invention may be a device which detects motion or the presence of a user in an active shower area. The motion sensor may be mounted to the front of the front spray base pointing outwards towards the active shower area. The motion sensor may be further communicatively connected to the PC board 38.

This invention may be utilized by starting the showerhead 10 using a mobile or other communication device via the PC board 38. Once started, the showerhead 10 will allow any cold water in the showerhead 10 and supply pipes to exit the showerhead 10. The temperature sensor 56 detects when the desired water temperature is reached, and the ball valve 80 is opened. The showerhead 10 is now ready for use by the user to take a shower. In some embodiments, the user may be notified through any number of means such as a mobile app or an audible alert.

The motion sensor detects the user entering the active shower area. The ball valve 80 is opened, and water begins to flow. The water is dispensed having the desired water temperature and the shower proceeds as normal.

During the shower process, the user may step back or out of the active shower area for any number of reasons including applying soap or shampoo. When the user steps out of the active shower area, the motion sensor detects their lack of presence in the active shower area, and the ball valve 80 is closed. This stops the flow of water thereby conserving water and energy to heat water which would otherwise just flow down the drain.

The user is able to start and stop the water flow by stepping in and out of the active shower area as needed. When the shower is completed, the user may turn the showerhead 10 off using a mobile or other communication device via the PC board 38.

Further embodiments of this invention may utilize buttons or other control devices in place of or as an alternative to the mobile or other communications devices. This would allow for manual starting and stopping of the showerhead 10.

In other embodiments of this invention, the showerhead 10 may include a ring of light emitting diodes (LED) which give a visual indication of the water temperature. Therefore, the user is able to see a visual indication of the water temperature and when the desired temperature is achieved.

In further embodiments of this invention, the PC board 38 may be further comprised of a water flow meter or other sensors which are capable of measuring and gathering data related to this invention as well as the process of the shower. These sensors and their data would then be available for processing and transmitting by the PC board 38 or other means.

In a further embodiment of this invention, several of the internal components are integrated together. One embodiment of this invention includes the integration of the PC board, generator, and ball valve. This integrated unit would significantly reduce the overall length of the showerhead of this invention, while simplifying assembly. Other embodiments of the showerhead of this invention may integrate further components and functions into fewer components or systems without affecting the scope or spirit of this invention.

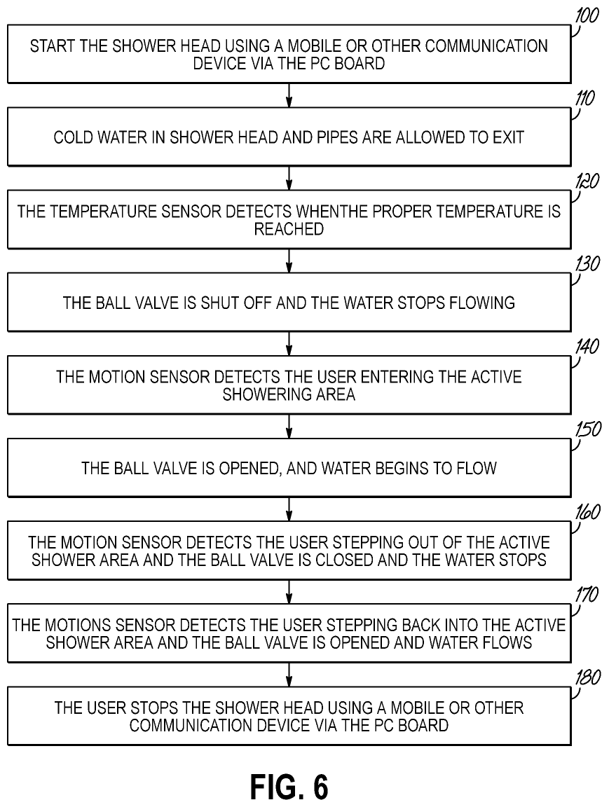

FIG. 6 is a flowchart of one mode of operation of the showerhead 10 of this invention. The user may start the showerhead 10 by using a mobile device in communication with the PCB 38 as in box 100. Cold water resident in the showerhead 10 and upstream pipes exits the showerhead 10 at no. The temperature sensor 56 detects when the desired water temperature is reached 120. The ball valve is then shuts and water ceases to flow 130. The motion sensor detects the user entering the active shower area 140 and the ball valve is opened to allow for water flow through the showerhead 10 at step 150. The motion sensor monitors when/if the user exits the active shower area and the ball valve is closed to stop water flow 160. The motion sensor may detect if the user re-enters the active shower area and the ball valve is opened to permit water flow through the showerhead 10 at step 170. The user may end the shower and terminate flow of water through the showerhead 10 via a mobile device in communication with the PCB at step 180.

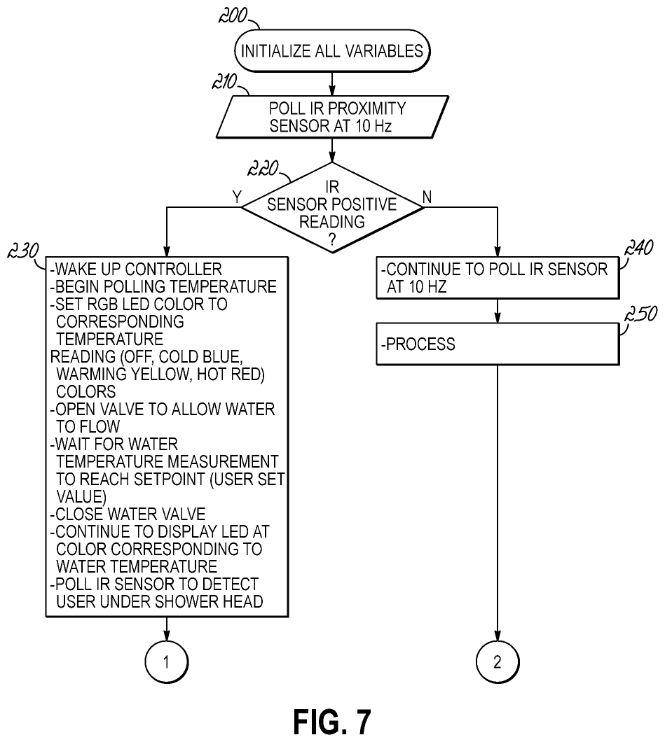

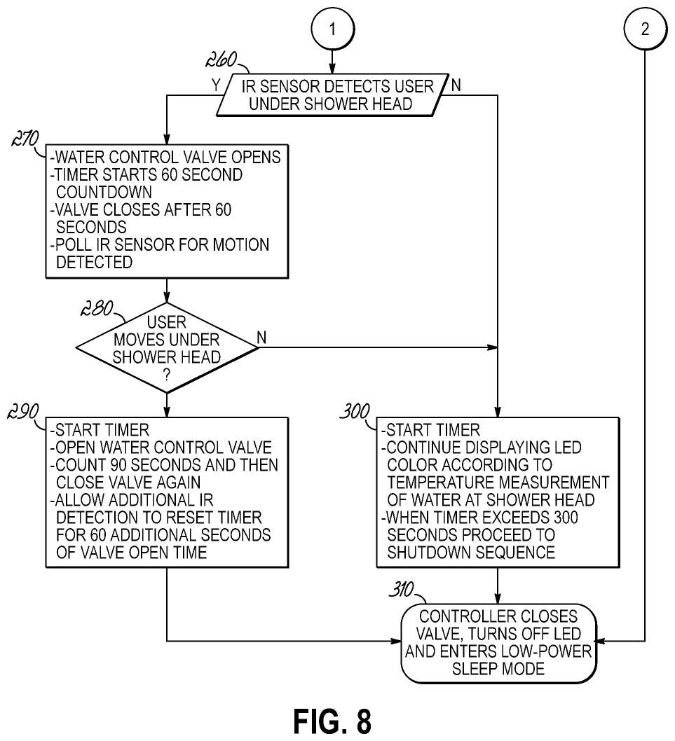

FIGS. 7-8 show another mode of operation of the showerhead 10 according to one embodiment of this invention. Once all of the variables are initiated 200 the motion or proximity IR sensor is polled 210. Once the IR proximity sensor has a positive reading 220 the operation of the showerhead 10 is initialized 230. If the IR sensor does not achieve a positive reading it continues to be polled 240 to continue the process 250.

Continuing with FIG. 8, if the IR sensor reading remains negative, the controller closes the valve and powers down the showerhead 10 at step 310. If the showerhead 10 is active and a user is detected in the active shower area 260, valve opens and a timer starts and motion in the active shower area continues to be monitored 270. If a user moves in the active shower area 280, the timer allows for additional water flow for a specified period of time, i.e., ninety seconds and continues to monitor for further activity 290. If user movement is not detected in the active shower area, the timer is started, the LED displays the water temperature and the shutdown sequence may begin after a specified time period 300 until shutdown is commenced 310. Modifications to this mode of operation are well within the scope of this invention.

Although the invention has been explained in relation to various embodiments, it is to be understood that many other possible modifications and variations can be made without departing from the spirit and scope of the invention From the above disclosure of the general principles of this invention and the preceding detailed description of at least one embodiment, those skilled in the art will readily comprehend the various modifications to which this invention is susceptible. Therefore, we desire to be limited only by the scope of the following claims and equivalents thereof.

We claim:

1. A showerhead for controlling a flow of water from a water source into an active shower area, the showerhead comprising:
a water inlet assembly coupling the showerhead to the water source;
a housing;
a plurality of nozzles for directing the water exiting the showerhead toward the active shower area;
a sensor directed at the active shower area to detect the presence of a user in the active shower area;
a valve configurable between open and closed positions in which the open position allows for the flow of water through the showerhead toward the active shower area and the closed position inhibits the flow of water through the showerhead; and
a controller to receive a signal from the sensor and move the valve to and between the open and closed positions in response to the signal to thereby conserve water when the user is absent from the active shower area.

2. The showerhead of claim 1 wherein the controller further comprises a printed circuit board.

3. The showerhead of claim 1 wherein the sensor further comprises a motion sensor positioned on a face of the showerhead confronting the active shower area.

4. The showerhead of claim 1 further comprising:
a temperature sensor to detect a temperature of the water; and
a temperature indicator to display the temperature of the water to the user.

5. The showerhead of claim 4 wherein the temperature indicator further comprises at least one color changing light emitting diode to indicate the temperature of the water to the user.

6. The showerhead of claim 1 wherein the valve further comprises an electrically activated ball valve.

7. The showerhead of claim 6 further comprising:
a solenoid to actuate the electrically activated ball valve for movement to and between the open and closed positions.

8. The showerhead of claim 1 further comprising:
an antennae operably coupled to the controller for receiving communications from a user device.

9. The showerhead of claim 1 further comprising:
a generator to produce electrical power for operation of the showerhead.

10. The showerhead of claim 1 further comprising:
a battery for storing electrical power for operation of the showerhead.

11. The showerhead of claim 1 further comprising:
a turbine to produce electrical power for operation of the showerhead.

12. A showerhead for controlling a flow of water from a water source into an active shower area, the showerhead comprising:
a water inlet assembly coupling the showerhead to the water source;
a housing;
a plurality of nozzles for directing the water exiting the showerhead toward the active shower area;
a motion sensor positioned on a face of the showerhead confronting the active shower area to detect the presence of a user in the active shower area;
an electrically activated ball valve configurable between open and closed positions in which the open position allows for the flow of water through the showerhead toward the active shower area and the closed position inhibits the flow of water through the showerhead;
a temperature sensor to detect a temperature of the water;
a temperature indicator to display the temperature of the water to the user;
a turbine generator to produce electrical power for operation of the showerhead; and
a printed circuit board controller to receive a signal from the sensor and move the valve to and between the open and closed positions in response to the signal to thereby conserve water when the user is absent from the active shower area.

13. The showerhead of claim 12 wherein the temperature indicator further comprises at least one color changing light emitting diode to indicate the temperature of the water to the user.

14. The showerhead of claim 12 further comprising:
a solenoid to actuate the electrically activated ball valve for movement to and between the open and closed positions.

15. The showerhead of claim 12 further comprising:
an antennae operably coupled to the controller for receiving communications from a user device.

16. The showerhead of claim 12 further comprising:
a battery for storing electrical power for operation of the showerhead.

17. A method for controlling a flow of water from a showerhead toward an active shower area, the method comprising:
coupling the showerhead to a water source;
detecting a temperature of the water flowing from the showerhead;
detecting the presence of a user in the active shower area;
stopping the flow of water from the showerhead by closing a valve in the showerhead when a desired temperature of the water is reached and the user is absent from the active shower area;
opening the valve when the user is detected in the active shower area; and
stopping the flow of water from the showerhead by closing the valve when the user exits the active shower area.

18. The method of claim 17 further comprising:
generating power within the shower head for closing and opening the valve.

19. The method of claim 17 further comprising:
remotely operating the showerhead with a user device.

20. The method of claim 17 further comprising:
displaying the temperature of the water flowing from the showerhead.
